(19) United States
(12) Patent Application Publication
(10) Pub. No.: US 2024/0316641 A1
(43) Pub. Date: Sep. 26, 2024

(54) 3D METAL PARTIAL PRINTING OF REFINER SEGMENTS

(71) Applicant: ANDRITZ INC., Alpharetta, GA (US)

(72) Inventors: Luc Gingras, Harrogate (GB); Yves Raymond, Milton, PA (US)

(73) Assignee: ANDRITZ INC., Alpharetta, GA (US)

(21) Appl. No.: 18/578,000

(22) PCT Filed: Aug. 31, 2022
(86) PCT No.: PCT/US2022/042222

§ 371 Date: Jan. 9, 2024

Related U.S. Application Data
(60) Provisional application No. 63/239,167, filed on Aug. 31, 2021.

(51) Int. Cl. B22F 10/31; B22F 10/50; B33Y 10/00; B33Y 50/02; B33Y 80/00

(52) U.S. Cl. CPC B22F 10/31; B22F 10/50; B33Y 10/00; B33Y 50/02; B33Y 80/00; B22F 2998/10

(57) ABSTRACT

A method for additive machining of a refiner plate segment having a feature pattern includes: fabricating the refiner plate segment with a partial feature pattern from a first material: performing optical scanning of the refiner plate segment to identify positions of features in the partial feature pattern: automatically generating first code for performing three-dimensional (3D) printing of a second material at first specified locations in the partial feature pattern from data obtained from the optical scanning; and performing 3D printing of the second material at the specified locations.

### BACKGROUND

Unless otherwise indicated herein, the materials described in this section are not prior art to the claims in this application and are not admitted to being prior art by inclusion in this section.

As part of the paper making process, lignocellulosic material, for example, wood chips and other fibrous material, is refined by mechanical refiners. A refiner for processing fibrous material typically includes refiner discs, one of which rotates with respect to the other. Other types of discs, for example, disperser discs, may perform other operations as part of the paper making process. Each disc may include multiple segments that, when assembled to the mechanical refiner, make up the complete disc.

Fabrication of the disc segments, also referred to as plate segments, is conventionally performed using a casting process. The refiner plate segments are typically cast from a single material. The single material may be a relatively soft material that minimizes breakage but wears quickly. Alternatively, the single material may be a relatively hard material that reduces wear but is prone to breakage.

### SUMMARY

This invention relates to methods for fabricating plate segments, and more particularly, but not exclusively, to methods for fabricating plate segments such as refiner plate segments, disperser plate segments, flinger plate segments, etc., using additive machining processes.

According to various aspects of the present disclosure, a method for additive machining of a refiner plate segment with a feature pattern is provided. In some aspects, the method may include operations including fabricating the refiner plate segment with a partial feature pattern from a first material; performing optical scanning of the refiner plate segment to identify positions of features in the partial feature pattern; automatically generating first code for performing three-dimensional (3D) printing of a second material at first specified locations in the partial feature pattern from data obtained from the optical scanning; and performing 3D printing of the second material at the specified locations.

According to various aspects of the present disclosure, a method for additive machining of a blank refiner plate segment without a feature pattern is provided. In some aspects, the method may include operations including fabricating the blank refiner plate segment without feature pattern from a first material; generating code for performing 3D printing of the feature pattern from design data for the feature pattern; and performing 3D printing of the of the feature pattern on the blank refiner plate segment with a second material to form a refiner plate segment

According to various aspects of the present disclosure, a method for refurbishing a feature pattern of a refiner plate segment using additive machining is provided. In some aspects, the method may include operations including obtaining a previously used refiner plate segment comprising a first material; performing a planarization operation to obtain a planar surface on top surfaces of features in a feature pattern; performing optical scanning of the refiner plate segment to identify positions of the features in the feature pattern; automatically generating code for performing 3D printing of a second material at specified locations in the feature pattern from data obtained from the optical scanning; and performing 3D printing of the second material at the specified locations.

According to various aspects of the present disclosure, a method for additive machining of a refiner plate segment is provided. In some aspects, the method may include operations including obtaining design data for the refiner plate segment; generating code for 3D printing of a refiner plate segment substrate; performing 3D printing of the refiner plate segment substrate with a first material; generating code for 3D printing of a feature pattern from the design data for the refiner plate segment; and performing 3D printing of the feature pattern with a second material.

### BRIEF DESCRIPTION OF THE DRAWINGS

Aspects and features of the various embodiments will be more apparent by describing examples with reference to the accompanying drawings, in which:

FIG. 1 is a diagram illustrating an example of bars of the feature pattern fabricated on a substrate according to various aspects of the present disclosure;

FIGS. 2A-2E are diagrams illustrating examples of bars of feature patterns fabricated on a blank plate segment according to various aspects of the present disclosure.

FIG. 3 is a flowchart illustrating an example of a method for additive machining of a plate segment with a feature pattern according to various aspects of the present disclosure;

FIG. 4 is a flowchart illustrating an example of a method for additive machining of a blank plate segment substrate without a feature pattern according to various aspects of the present disclosure;

FIG. 5 is a flowchart illustrating an example of a method for refurbishing a feature pattern of a plate segment using additive machining according to various aspects of the present disclosure;

FIG. 6 is a flowchart illustrating an example of a method for additive machining of a plate segment according to various aspects of the present disclosure; and

FIG. 7 is a flowchart illustrating an example of a method for additive machining of a plate segment having a partial feature pattern according to various aspects of the present disclosure.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

Similar reference characters indicate corresponding parts throughout the several views unless otherwise stated. Although the drawings represent embodiments of various features and components according to the present disclosure, the drawings are not necessarily to scale and certain features may be exaggerated in order to better illustrate embodiments of the present disclosure, and such exemplifications are not to be construed as limiting the scope of the present disclosure.

Except as otherwise expressly stated herein, the following rules of interpretation apply to this specification: (a) all words used herein shall be construed to be of such gender or number (singular or plural) as to circumstances require; (b) the singular terms “a,” “an,” and “the,” as used in the specification and the appended claims include plural references unless the context clearly dictates otherwise; (c) the antecedent term “about” applied to a recited range or value denotes an approximation within the deviation in the range or values known or expected in the art from the measurements; (d) the words “herein.” “hereby,” “hereto,” “hereinbefore,” and “hereinafter,” and words of similar import, refer to this specification in its entirety and not to any particular paragraph, claim, or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms, “comprising,” “having,” “including,” and “containing” are to be construed as open-ended terms (i.e., meaning “including but not limited to”).

Recitation of ranges of values herein are merely intended to serve as a shorthand method of referring individually to each separate value falling within the range of within any sub ranges there between, unless otherwise clearly indicated herein. Each separate value within a recited range is incorporated into the specification or claims as if each separate value were individually recited herein. Where a specific range of values is provided, it is understood that each intervening value, to the tenth or less of the unit of the lower limit between the upper and lower limit of that range and any other stated or intervening value in that stated range or sub range hereof, is included herein unless the context clearly dictates otherwise. All subranges are also included. The upper and lower limits of these smaller ranges are also included therein, subject to any specifically and expressly excluded limit in the stated range.

Aspects of the present disclosure can provide methods for fabricating plate segments such as refiner plate segments, disperser plate segments, flinger plate segments, etc., generally referred to herein as refiner plate segments or plate segments, using 3D printing processes, also referred to herein as additive machining processes, to perform additive machining operations. The disclosed methods may also be used to refurbish worn or damaged refiner plate segments. The additive machining process may be utilized to fabricate plate segments having two or more materials, for example, but not limited to, a relatively soft substrate material that minimizes breakage combined with a relatively hard material that reduces wear for the feature pattern.

According to some aspects of the present disclosure, optical scanning, for example 3D laser scanning, of a plate segment having a feature pattern may be used to obtain feature pattern data for 3D printing of additional material onto features of an existing feature pattern. A plate segment having a feature pattern may be fabricated in a conventional manner, for example, by casting or another conventional fabrication method. The feature pattern may include for example, but not limited to, bars, grooves, dams, etc. In some cases, features in the feature pattern may be dimensioned such that the features are wider at a top surface than at a base of the feature.

In some cases, the features of the feature pattern may be planarized such that the top surface of each of the features lie in a same plane. The plate segment may be optically scanned, for example, using 3D laser scanning equipment or other image capture equipment such as 2D digital photo or 3D digital photo via camera or similar, or other types of scanning equipment such as radar-based scanning equipment, to identify the dimensions and locations of the features in the feature pattern. The scanning can eliminate a need for obtaining design data to find exact dimensions to determine location and size of the features and can also eliminate a need for precise positioning of the plate segment for performing the 3D printing operations.

Based on the data obtained from the scanning operation, the top surfaces of the features may be identified, and the type and thickness of material to be added in the locations at which it should be added may be selected by an operator. For example, while the substrate and feature pattern of the refiner plate may be cast from a relatively ductile material to minimize breakage, additional material may be added to selected portions of the feature pattern to increase hardness and minimize wear.

Programming code for 3D printing of the additional material on the selected surfaces of the feature pattern may be automatically generated from the data obtained from scanning the plate segment. The programming code may be, for example, code for programming computer numerical controlled (CNC) 3D printing equipment. The 3D printing equipment may deposit and melt/fuse the additional material onto the tops of the features, gradually building up the height of the features to a specified height based on design specifications and the pattern identified by the scan. In some implementations, the 3D printing may be performed as the scanning is being performed.

The additional material may be added on top of existing features. It should be appreciated that one, two, three, or more additional materials may be added using the additive machining processes. While 3D printing is discussed throughout the disclosure as a method for additive machining, material may be added using any suitable method such as welding, sintering, gluing, forging, 3D printing, etc. The operations may add material in a range of approximately 0.5 mm to 5 mm of material on the top surfaces of the features. The added material can be of the same composition as the plate segments substrate material or can be a different material such as a harder wear-resistant material deposited on top of a softer and more resilient (e.g., breakage-resistant) material used for the plate segment substrate and lower portion of the features. The resulting plate segment may be used directly, and/or heat-treated and/or re-ground to a flat, tapered, conical, cylindrical surface.

One process technology for use with the present inventive concept may be Direct Metal Laser Deposition (DMLD). DMLD may be used with either metal powder or metal wire as a deposit source. In some cases, metal wire may provide better precision for forming features and may provide an improved surface finish compared to metal powder. DMLD uses a laser to melt the metal powder or wire onto the substrate which, according to various aspects of the present disclosure may be a refiner plate blank segment, a worn refiner plate segment, or a partial bar height refiner plate segment where only tops of bars may be added in a different, e.g., harder, material than the substrate. Many variations of this process exist and may be known as, for example, but not limited to, Laser Cladding or Directed Energy Deposition.

Laser Engineered Net Shaping (LENS) is another process technology that may be used with the present inventive concept. LENS may be applicable in cases where damaged parts are being repaired by adding material in damaged areas.

Tungsten Inert Gas (TIG) welding, also known as Gas Tungsten Arc Welding (GTAW), is yet another additive machining process technology that that may be used with the present inventive concept. TIG Welding also uses a wire as a deposition source for 3D additive manufacturing.

The additive machining technologies may use the same or similar materials to those used in manufacturing of refiner plates. While the present disclosure provides examples of materials that may be used in the additive machining process technologies, a wide range of other materials, existing or developed in the future, may be used to provide enhanced properties and performance of the various embodiments. Using additive machining technologies, multi-material bar designs may be realized with refiner plate features that may be either softer at the base and/or at the center of the features, depending on the requirements of the application. Multi-material bar designs can provide improved wear resistance from a top or outer layer, together with the toughness of the softer base material.

The base (e.g., lower portion) of the bars may be made from a ductile material, such as an austenitic stainless steel or other alloys with hardness less than 45 HRC, for example, less than 42 HRC or 40 HRC. The material to be added on top of the bars can be harder, for example, greater than 45 HRC, 50 HRC, or 55 HRC. The materials may be, for example, but not limited to, martensitic stainless steels or high carbon white irons. Alternatively, more exotic materials including titanium, tool steels, and any other material that can be fused to the base material and offers good wear resistance may be used.

In some cases, additive machining technologies may be used to fabricate features, for example a bar/groove pattern, on a blank refiner plate disc or segment. A refiner plate disc or segment may be fabricated according to a typical manufacturing process, for example, by casting or another method. The fabricated disc or segment may have a blank surface, e.g., a surface with no refining features, upon which an additive machining process may be used to fabricate the refining features. The refining features may include any features utilized to process feedstock in a refining machine.

Positioning of the blank segment machining equipment may be precisely identified visually to enable additive machining without the need for precise set up of the blank part on the machine. The visual measurement can be performed via digital photo, 3D photo/imaging, laser scan, radar scan, or other methods capable of precisely digitally defining the blank part dimensions and positioning the blank part on the additive machining equipment in order to allow the precise addition of metal to the blank disc or segment. A programmed feature design such as a bar/groove design may be printed a surface of the blank disc segment. The entirety of the refining bars and/or other features may be printed through metal deposit from a programmed image. Bars and/or other features may be built up using one material or multiple different materials.

The blank segment may be made of any type of metal that the alloy used to form the bars can fuse to. The hardness/softness of the blank segment may depend on the application. When a blank segment without bars is used, the bars can be formed from a single alloy or multiple alloys. When the bars are formed with multiple alloys, the top, the outer portion and/or some of the sides or edges can be made of a harder material.

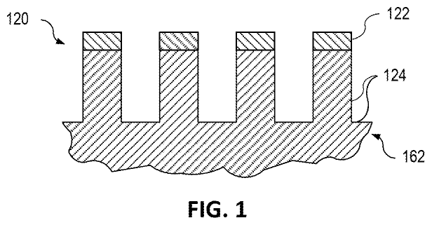

FIG. 1 is a diagram illustrating an example of bars 120 of the feature pattern fabricated on a substrate 160 according to various aspects of the present disclosure. Referring to FIG. 1, the substrate 160 and base of the bars 120 may be formed of the same material, for example, a relatively ductile alloy 124 such as austenitic stainless steel or another alloy. The substrate 160 and bases of the bars 120 may be fabricated using conventional processes, for example, but not limited to, a casting process or other process. Alternatively, the substrate 160 and bases of the bars 120 may be fabricated using an additive machining process technology. A wear-resistant alloy 122, for example, martensitic stainless steel or another alloy, may be deposited on the top portion of the bars 120 using an additive machining process. It should be appreciated that one, two, three, or more additional materials may be added using the additive machining processes. In some implementations, the substrate and bases of the bars may be formed from multiple materials, for example, a combination of alloys.

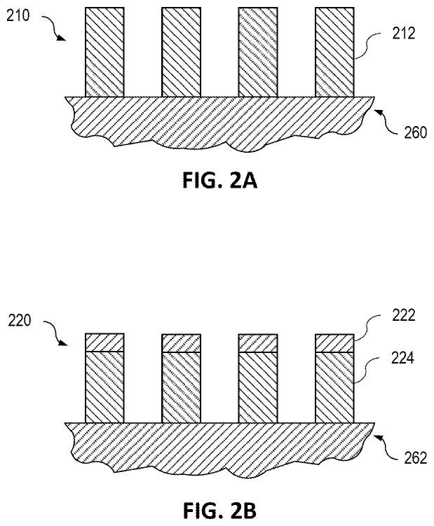

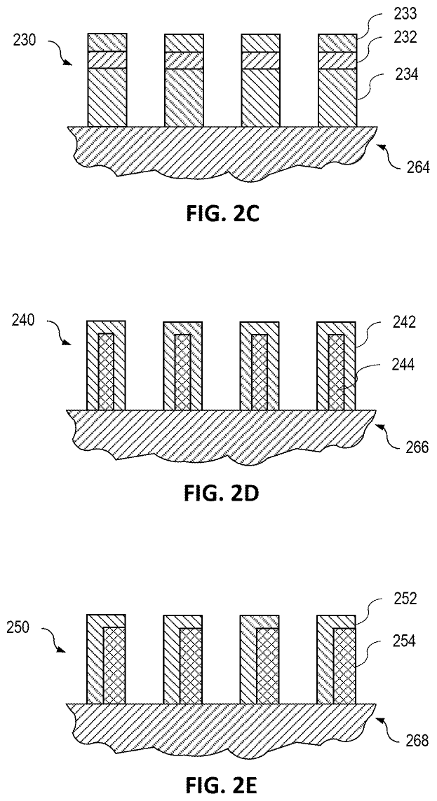

FIGS. 2A-2E are diagrams illustrating examples of bars of a feature pattern fabricated on a blank plate segment according to various aspects of the present disclosure. Referring to FIG. 2A, bars 210 of a feature pattern may be formed from a single alloy 212 on a blank segment 260 (e.g., substrate). A DMLD process or other additive machining process technology may be used to deposit bars formed from, for example, martensitic stainless steel or another alloy on the blank segment fabricated from, for example, austenitic stainless steel or another alloy. In some implementations, the substrate may be formed from multiple materials, for example, a combination of alloys.

FIG. 2B illustrates an example of bars 220 of a feature pattern fabricated with two alloys 222, 224 on a plate segment 262. The base of the bars 220 may be formed of a relatively ductile alloy 224, for example, austenitic stainless steel or another alloy or a combination of alloys, with a harder, more wear-resistant alloy 222, for example, martensitic stainless steel or another alloy deposited on the tops of the bars 220. In some cases, the plate segment 262 may be a blank plate segment (e.g., substrate) and the bars 220 of the feature pattern may be fabricated on the blank plate segment 262. In some cases, the bars 220 of the feature pattern may be previously fabricated on the plate segment 262 with the ductile alloy 224 by, for example, a casting process or another process. The wear-resistant alloy 222 may be fabricated using an additive machining process. In some cases, the plate segment 262 may be a previously used plate segment with the bars 220 of the feature pattern having the ductile alloy 224 present on the used plate segment. In some implementations, the substrate may be formed from multiple materials, for example, a combination of alloys. The wear-resistant alloy 222 may be fabricated using an additive machining process. It should be appreciated that one, two, three, or more additional materials may be added using the additive machining processes.

FIG. 2C illustrates an example of bars 230 of a feature pattern fabricated with three alloys 232, 233, 234 on a plate segment 264. The base of the bars 230 may be formed of a relatively ductile alloy 234, for example, austenitic stainless steel or another alloy, with a first alloy 232, deposited on the tops of the bars 230. This first deposited alloy may have more wear resistance than the bar alloy 234, or it may be an intermediate alloy that helps proper adhesion between the bar alloy 234 and the top, more wear-resistant alloy 233. The second alloy 233 different from the first alloy 232, for example, martensitic stainless steel or another alloy, may be deposited on top of the first alloy 232. In some cases, the plate segment 264 may be a blank plate segment and the bars 234 of the feature pattern may be fabricated on the blank plate segment 264. In some cases, the bars 234 of the feature pattern may be previously fabricated on the plate segment 264 with the ductile alloy 234 by, for example, a casting process or another process. The wear-resistant alloy 233 may be fabricated using an additive machining process. In some cases, the plate segment 264 may be a previously used plate segment with the bars 230 of the feature pattern having the ductile alloy 234 present on the used plate segment. The wear-resistant alloy 233 may be fabricated using an additive machining process. In some implementations, the substrate may be formed from multiple materials, for example, a combination of alloys. It should be appreciated that one, two, three, or more additional materials may be added using the additive machining processes.

FIG. 2D illustrates another example of bars 240 of a feature pattern fabricated with two alloys 242, 244 on a plate segment 266. In FIG. 2D, an inner portion of the bars 240 may be formed of a relatively ductile alloy 244, for example, austenitic stainless steel or another alloy, with a harder, more wear-resistant alloy 242, for example, martensitic stainless steel or another alloy deposited on the outer portions of the bars 240. In some cases, the plate segment 266 may be a blank plate segment and the bars 240 of the feature pattern may be fabricated on the blank plate segment 266. In some cases, the bars 240 of the feature pattern may be previously fabricated on the plate segment 266 with the ductile alloy 244 by, for example, a casting process or another process. The wear-resistant alloy 242 may be fabricated using an additive machining process. In some cases, the plate segment 266 may be a previously used plate segment with the bars 240 of the feature pattern having the ductile alloy 244 present on the used plate segment. The wear-resistant alloy 242 may be fabricated using an additive machining process. In some implementations, the substrate may be formed from multiple materials, for example, a combination of alloys. It should be appreciated that one, two, three, or more additional materials may be added using the additive machining processes.

FIG. 2E illustrates still another example of bars 250 of a feature pattern fabricated with two alloys 252, 254 on a plate segment 268. As shown in FIG. 2E, one or more sides of the bars 250 may be formed of a relatively ductile alloy 254, for example, austenitic stainless steel or another alloy, with a harder, more wear-resistant alloy 252, for example, martensitic stainless steel or another alloy deposited on the remaining sites of the bars 250. In some cases, the plate segment 268 may be a blank plate segment and the bars 250 of the feature pattern may be fabricated on the blank plate segment 268. In some cases, the bars 250 of the feature pattern may be previously fabricated on the plate segment 268 with the ductile alloy 254 by, for example, a casting process or another process. The wear-resistant alloy 252 may be fabricated using an additive machining process. In some cases, the plate segment 268 may be a previously used plate segment with the bars 250 of the feature pattern having the ductile alloy 254 present on the used plate segment. In some implementations, the substrate may be formed from multiple materials, for example, a combination of alloys. The wear-resistant alloy 252 may be fabricated using an additive machining process.

In some cases, additive machining processes may be performed on surfaces of the tops of features, for example, but not limited to, refining bars, dams or other features, on an existing design. The features may be located and precisely identified using, for example, 3D laser scanning equipment or other optical scanning equipment, acoustic-based scanning equipment, radar-based scanning equipment, etc., and location and dimension measurements transformed into a 3D printing program. Additive machining may be used to deposit material at the identified locations based on the position of the disc or segment on the machining table without need for precise set-up. Optical scanning techniques may be particularly advantageous to refurbish a previously used refiner disc or segment that has been prepared, for example by resurfacing or planarizing, to provide features of uniform height, or for a purpose-made segment that is fit for the purpose of adding harder material on refining bar tops and/or edges.

In some cases, sintering and/or heat treatment of the part after or during additive machining may be performed to ensure desired materials properties such as hardness are achieved. Optional surface quality processing via shot-peening, sandblasting, or any other suitable means, may also be performed. Optionally, surface grinding on the tops of the features to ensure flatness of the final parts and sharp edges on the features may be performed. Electro-polishing may also be used when a very smooth surface on the features is desired.

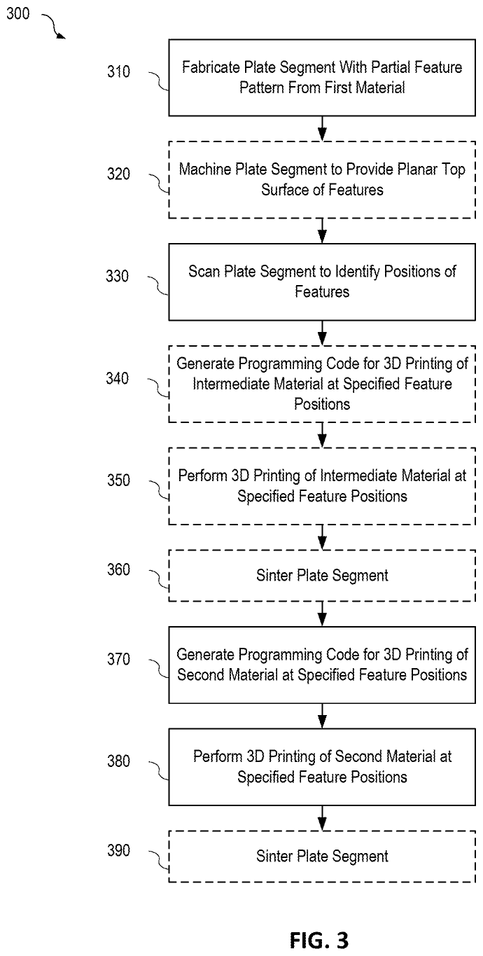

FIG. 3 is a flowchart illustrating an example of a method 300 for additive machining of a plate segment with a feature pattern according to some aspects of the present disclosure. Referring to FIG. 3, at block 310, a plate segment with a partial feature pattern may be fabricated. The plate segment may be, for example, but not limited to, a refiner plate segment, a disperser plate segment, a flinger plate segment, or other plate segment. The plate segment may be fabricated based on design data specifying features of the feature pattern as well as locations of features where additive machining may be performed. The plate segment may be a planar refiner plate segment, a cylindrical refiner plate segment, a conical refiner plate segment, or a single piece circle. The partial feature pattern may include, but not be limited to, bars, grooves, dams, channels, or other features. The plate segment may be fabricated using a casting process or other process. The partial feature pattern may be a feature pattern having features with a height as determined from a plate segment substrate. The height of the partial feature pattern may be less than a designed height for the features. In some cases, features in the feature pattern may be dimensioned such that the features are wider at a top surface than at a base of the feature.

At block 320, an optional planarization operation may be performed. The plate segment may be machined to obtain a planar surface such that the top surfaces of the features in the partial feature pattern lie in a same plane. In the case of a curved plate segment, the optional planarization operation may result in the top surfaces of the features in the partial feature pattern having a same height with respect to a base portion of the plate segment.

At block 330, the plate segment may be scanned to determine positions and heights of the features in the partial feature pattern. The plate segment may be scanned by, for example, but not limited to, 3D laser scanning equipment or other optical scanning equipment, acoustic-based scanning equipment, radar-based scanning equipment, etc. The scanning operation may identify a perimeter of the plate segment and may generate a three-dimensional map that defines the positions and dimensions of the features in the partial feature pattern with respect to the perimeter of the plate segment. Thus, in this case, no specific alignment of the plate segments may be needed. In some cases, the positions and dimensions of the features in the partial feature pattern may be obtained from design data for the plate segment. Alternatively, the plate segment may be positioned in a predetermined way in the 3D printing equipment. For example, the plate segment may be positioned via a fixture set at a known location and orientation in the 3D printing equipment.

At block 340, an intermediate material may optionally be applied. In some cases, an intermediate material may be applied to promote a stronger bond between the material from which the plate segment is fabricated and a more wear resistant material to be added to features in the partial feature pattern. When an intermediate material is to be applied, an optional operation of generating programming code for 3D printing of the intermediate material at specified feature positions may be performed. The generated programming code may be code for operating computer numerical controlled (CNC) 3D printing equipment. The intermediate material may be applied to effect secure bonding of the first material to a second material. The features to which the intermediate material will be applied may be selected by an operator. The programming code for 3D printing of the intermediate material may be generated automatically from the 3D scanning data and the selected features.

At block 350, when an intermediate material is to be applied, an optional operation of 3D printing of the intermediate material at the specified feature positions may be performed. Based on the programming code generated from the 3D scanning data and the selected features, the intermediate material may be 3D printed on the features at the identified locations.

At block 360, when an intermediate material is to be applied, an optional sintering operation may be performed. The sintering operation may be performed to fuse the intermediate material to the first material thereby increasing the strength and structural integrity of the materials. The sintering may be performed as the intermediate material is printed on the identified features, for example, using a laser sintering process. Alternatively or additionally, the sintering may be accomplished by heat treating the plate segment.

At block 370, programming code for 3D printing of the second material at specified feature positions may be generated. In some cases, the program code for 3D printing may be available from the design data of the plate segment. The second material may be a more wear resistant material to be added to identified features in the partial feature pattern. In some cases, the second material may be the same as the first material. The features to which the second material will be applied may be selected by an operator. The generated programming code may be code for operating computer numerical controlled (CNC) 3D printing equipment. The code for 3D printing of the second material may be generated automatically from the 3D scanning data and the selected features. In some cases, two or more additional materials may be 3D printed at the specified locations based on the code for 3D printing of the second material.

At block 380, an operation of 3D printing of the second material at the specified feature positions may be performed. Based on the programming code generated from the 3D scanning data and the selected features, the second material may be 3D printed on the features at the identified locations. It should be appreciated that the additive machining process may be performed for the addition of more than one second material.

At block 390, an optional sintering operation may be performed. The sintering operation may be performed to fuse the second material to the first material (or the intermediate material when used) thereby increasing the strength and structural integrity of the materials. The sintering may be performed as the second material is printed on the identified features, for example, using a laser sintering process. Alternatively or additionally, the sintering may be accomplished by heat treating the plate segment. In some cases, a planarization operation may be performed on the plate segment.

The specific operations illustrated in FIG. 3 provide a particular method 300 for additive machining of a plate segment with a feature pattern according to an embodiment of the present disclosure. Other sequences of operations may also be performed according to alternative embodiments. For example, alternative embodiments of the present disclosure may perform the operations outlined above in a different order. Moreover, the individual operations illustrated in FIG. 3 may include multiple sub-operations that may be performed in various sequences as appropriate to the individual operation. Furthermore, additional operations may be added or removed depending on the particular applications.

According to some aspects of the present disclosure, the 3D printing process may be used to fabricate feature patterns on a blank plate segment substrate. Rather than fabricating a plate segment having a feature pattern by conventional methods such as casting or another conventional fabrication method, a blank plate segment substrate having no feature pattern may be fabricated. The feature pattern may subsequently be added via additive machining such as 3D printing. The feature pattern may be added using the same material as the plate segment substrate or a different material, such as a hard, wear-resistant material.

Using design data obtained for the feature pattern, programming code for 3D printing of the feature pattern on the blank plate segment substrate may be generated. The programming code may be, for example, code for programming computer numerical controlled (CNC) 3D printing equipment. The 3D printing equipment may deposit and melt/fuse the additional material onto the blank plate segment substrate to produce the feature pattern.

The method can use either a single metallurgy for all added features which may be the same or different from the plate segment substrate, or it can use multiple metallurgies such as on the bottom and top of the features, the middle (e.g., core), and/or outer surfaces of the features, the different surfaces/sides of the features, different parts of the plate segments or different zones in the plate segments, and/or different plate features (e.g., making dams of a different material). The resulting plate segment may be used directly, and/or heat-treated and/or re-ground to a flat, tapered, conical, or cylindrical surface.

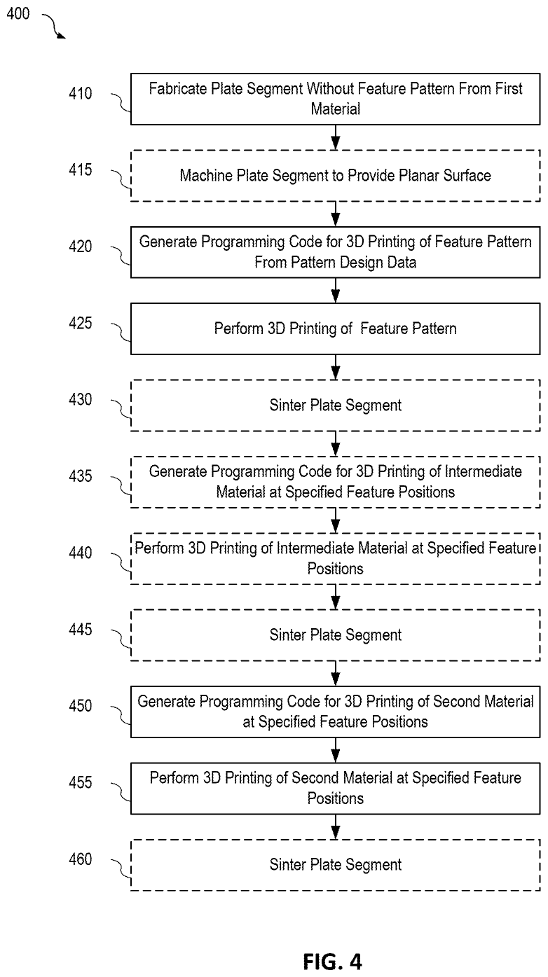

FIG. 4 is a flowchart illustrating an example of a method 400 for additive machining of a blank plate segment substrate without a feature pattern according to some aspects of the present disclosure. Referring to FIG. 4, at block 410, a plate segment substrate without a feature pattern may be fabricated. The plate segment may be a planar refiner plate segment, a cylindrical refiner plate segment, a conical refiner plate segment, or a single piece circle. The plate segment substrate may be, for example, but not limited to, a refiner plate segment substrate, a disperser plate segment substrate, a flinger plate segment substrate, or other plate segment substrate. The plate segment substrate may be fabricated using a casting process or other process.

At block 415, an optional planarization operation may be performed. The plate segment substrate may be machined to obtain a planar surface such that the top surface of the plate segment substrate lies in a same plane. In the case of a curved plate segment, the optional planarization operation may result in the plate segment substrate having a uniform thickness.

At block 420, programming code for 3D printing of the feature pattern may be generated. The generated programming code may be code for operating computer numerical controlled (CNC) 3D printing equipment. The programming code for 3D printing of the feature pattern may be generated automatically from feature pattern design data. In some cases, the programming code for 3D printing of the feature pattern may be available from the existing plate segment design. The feature pattern design data may specify the types and dimensions of features for example, but not limited to bars, grooves, dams, etc., and their locations on the plate segment. In some cases, features in the feature pattern may be dimensioned such that the features are wider at a top surface than at a base of the feature.

At block 425, an operation of 3D printing of the feature pattern may be performed. Based on the programming code generated from the feature pattern design data, the feature pattern may be 3D printed on the plate segment substrate. In some cases, for example when the features are printed from a different material than the material from which the plate segment substrate was fabricated, an intermediate material may be applied to the plate segment substrate in a same pattern as the feature pattern to promote secure bonding the plate segment substrate material to the material from which the features of the feature pattern will be fabricated.

At block 430, an optional sintering operation may be performed. The sintering operation may be performed to fuse the material from which the features are fabricated to the material from which the plate segment substrate is fabricated (or the intermediate material when used) thereby increasing the strength and structural integrity of the materials. The sintering may be performed as the material for the feature pattern is printed on the plate segment substrate, for example, using a laser sintering process. Alternatively or additionally, the sintering may be accomplished by heat treating the plate segment (e.g., the plate segment substrate and 3D printed feature pattern).

At block 435, an intermediate material may optionally be applied. In some cases, an intermediate material may be applied to promote a stronger bond between the material from which the features are fabricated and a more wear resistant material to be added to features in the feature pattern. When an intermediate material is to be applied, an optional operation of generating programming code for 3D printing of the intermediate material at specified feature positions may be performed. The generated programming code may be code for operating computer numerical controlled (CNC) 3D printing equipment. The intermediate material may be applied to effect secure bonding the first material to a second material. The features to which the intermediate material will be applied may be selected by an operator. The programming code for 3D printing of the intermediate material may be generated automatically from the 3D scanning data and the selected features.

At block 440, when an intermediate material is to be applied, an optional operation of 3D printing of the intermediate material at the specified feature positions may be performed. Based on the code generated from the 3D scanning data and the selected features, the intermediate material may be 3D printed on the features at the identified locations.

At block 445, when an intermediate material is to be applied, an optional sintering operation may be performed. The sintering operation may be performed to fuse the intermediate material to the first material thereby increasing the strength and structural integrity of the materials. The sintering may be performed as the intermediate material is printed on the identified features, for example, using a laser sintering process. Alternatively or additionally, the sintering may be accomplished by heat treating the plate segment.

At block 450, code for 3D printing of the second material at specified feature positions may be generated. The second material may be and a more wear resistant material to be added to identified features in the feature pattern. The features to which the second material will be applied may be selected by an operator. The generated code may be code for operating computer numerical controlled (CNC) 3D printing equipment. The programming code for 3D printing of the second material may be generated automatically from the feature pattern design data and the selected features.

At block 455, an operation of 3D printing of the second material at the specified feature positions may be performed. Based on the code generated from the feature pattern design data and the selected features, the second material may be 3D printed on the features at the identified locations. It should be appreciated that the additive machining process may be performed for the addition of more than one second material.

At block 460, an optional sintering operation may be performed. The sintering operation may be performed to fuse the second material to the first material (or the intermediate material when used) thereby increasing the strength and structural integrity of the materials. The sintering may be performed as the second material is printed on the identified features, for example, using a laser sintering process. Alternatively or additionally, the sintering may be accomplished by heat treating the plate segment. In some cases, a planarization operation may be performed on the plate segment.

The specific operations illustrated in FIG. 4 provide a particular method 400 for additive machining of a blank plate segment substrate without a feature pattern according to an embodiment of the present disclosure. Other sequences of operations may also be performed according to alternative embodiments. For example, alternative embodiments of the present disclosure may perform the operations outlined above in a different order. Moreover, the individual operations illustrated in FIG. 4 may include multiple sub-operations that may be performed in various sequences as appropriate to the individual operation. Furthermore, additional operations may be added or removed depending on the particular applications.

According to some aspects of the present disclosure, the 3D printing process may be used to refurbish a feature pattern of a plate segment. After obtaining a previously used plate segment, the features of the feature pattern may be planarized such that the top surface of each of the features lie in a same plane. The plate segment may be optically scanned, for example, using 3D laser scanning equipment or other image capture equipment such as 3D digital photo or 3D digital photo via camera or similar, or other types of scanning equipment such as radar-based scanning equipment, to identify the dimensions and locations of the features in the feature pattern. The scanning can eliminate a need for obtaining design data to find exact dimensions to determine location and size of the features.

Based on the data obtained from the scanning operation, the top surfaces of the features may be identified, and the type and thickness of material to be added in the locations at which it should be added may be selected by an operator. For example, while the substrate and feature pattern of the refiner plate may be cast from a relatively ductile material to minimize breakage, additional material may be added to selected portions of the feature pattern to increase hardness and minimize wear.

Code for 3D printing of the additional material on the selected surfaces of the feature pattern may be automatically generated from the data obtained from scanning the plate segment. The code may be, for example, code for programming computer numerical controlled (CNC) 3D printing equipment for computer-controlled metal deposition/printing onto the tops of the bars. The 3D printing equipment may deposit and melt/fuse the additional material onto the tops of the features, gradually building up the height of the features to a specified height based on design specifications and the pattern identified by the scan. In some cases, features in the feature pattern may be dimensioned such that the features are wider at a top surface than at a base of the feature. In some implementations, the 3D printing may be performed as the scanning is being performed.

The additional material addition may be added on top of existing features. While 3D printing is discussed throughout the disclosure as a method for additive machining, material may be added using any suitable method such as welding, sintering, gluing, forging, 3D printing, etc. The operations may add material in a range of approximately 0.5 mm to 5 mm of material on the top surfaces of the features. The added material can be of the same composition as the plate segments substrate material or can be a different material such as a harder wear-resistant material deposited on top of a softer and more resilient (e.g., breakage-resistant) material used for the plate segment substrate and lower portion of the features. The resulting plate segment may be used directly, and/or heat-treated and/or re-ground to a flat, tapered, conical, cylindrical surface.

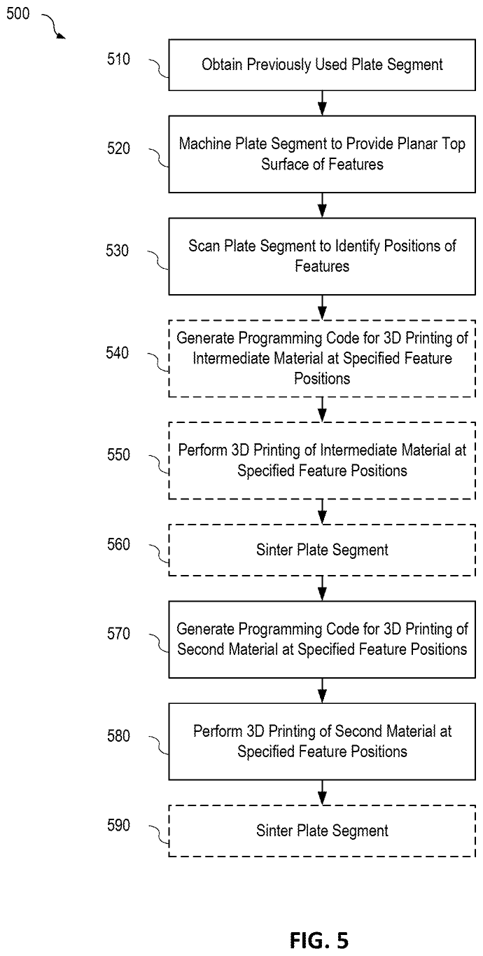

FIG. 5 is a flowchart illustrating an example of a method 500 for refurbishing a feature pattern of a plate segment using additive machining according to some aspects of the present disclosure. Referring to FIG. 5, at block 510, a previously used plate segment may be obtained. The previously used plate segment may be a conical or cylindrical plate segment or maybe a single piece circle. The features (e.g., bars, grooves, dams, etc.) of the previously used plate segment may be worn such that their dimensions no longer conform to manufacturing tolerances.

At block 520, a planarization operation may be performed. The plate segment may be machined to obtain a planar surface such that the top surfaces of the features in the feature pattern lie in a same plane. In the case of a curved plate segment, the planarization operation may result in the top surfaces of the features in the feature pattern having a same height with respect to a base portion of the plate segment.

At block 530, the plate segment may be scanned to determine positions of the features in the feature pattern. The plate segment may be scanned by, for example, but not limited to, 3D laser scanning equipment or other optical scanning equipment, acoustic-based scanning equipment, radar-based scanning equipment, etc. The scanning operation may identify a perimeter of the plate segment and may generate a three-dimensional map that defines the positions and dimensions of the features in the feature pattern with respect to the perimeter of the plate segment. Thus, no specific alignment of the plate segments may be needed.

At block 540, an intermediate material may optionally be applied. In some cases, an intermediate material may be applied to promote a stronger bond between the material from which the plate segment is fabricated and a more wear resistant material to be added to features in the feature pattern. When an intermediate material is to be applied, an optional operation of generating programming code for 3D printing of the intermediate material at specified feature positions may be performed. The intermediate material may be applied to effect secure bonding the first material to a second material. The features to which the intermediate material will be applied may be selected by an operator. The generated programming code may be code for operating computer numerical controlled (CNC) 3D printing equipment. The programming code for 3D printing of the intermediate material may be generated automatically from the 3D scanning data and the selected features.

At block 550, when an intermediate material is to be applied, an optional operation of 3D printing of the intermediate material at the specified feature positions may be performed. Based on the programming code generated from the 3D scanning data and the selected features, the intermediate material may be 3D printed on the features at the identified locations.

At block 560, when an intermediate material is to be applied, an optional sintering operation may be performed. The sintering operation may be performed to fuse the intermediate material to the first material thereby increasing the strength and structural integrity of the materials. The sintering may be performed as the intermediate material is printed on the identified features, for example, using a laser sintering process. Alternatively or additionally, the sintering may be accomplished by heat treating the plate segment.

At block 570, programming code for 3D printing of the second material at specified feature positions may be generated. The second material may be the same as the first material. In some cases, a more wear resistant material to be added to identified features in the feature pattern. The features to which the second material will be applied may be selected by an operator. The generated programming code may be code for operating computer numerical controlled (CNC) 3D printing equipment. The programming code for 3D printing of the second material may be generated automatically from the 3D scanning data and the selected features.

At block 580, an operation of 3D printing of the second material at the specified feature positions may be performed. Based on the programming code generated from the 3D scanning data and the selected features, the second material may be 3D printed on the features at the identified locations. It should be appreciated that the additive machining process may be performed for the addition of more than one second material.

At block 590, an optional sintering operation may be performed. The sintering operation may be performed to fuse the second material to the first material (or the intermediate material when used) thereby increasing the strength and structural integrity of the materials. The sintering may be performed as the second material is printed on the identified features, for example, using a laser sintering process. Alternatively or additionally, the sintering may be accomplished by heat treating the plate segment. In some cases, a planarization operation may be performed on the plate segment.

The specific operations illustrated in FIG. 5 provide a particular method 500 for refurbishing a feature pattern of a plate segment using additive machining according to an embodiment of the present disclosure. Other sequences of operations may also be performed according to alternative embodiments. For example, alternative embodiments of the present disclosure may perform the operations outlined above in a different order. Moreover, the individual operations illustrated in FIG. 5 may include multiple sub-operations that may be performed in various sequences as appropriate to the individual operation. Furthermore, additional operations may be added or removed depending on the particular applications.

According to some aspects of the present disclosure, the 3D printing process may be used to fabricate the complete plate segment including the substrate and feature pattern. Using design data obtained for the plate segment, programming code for 3D printing of the plate segments substrate and feature pattern on the plate segment substrate may be generated. The code may be, for example, code for programming computer numerical controlled (CNC) 3D printing equipment. The 3D printing equipment may deposit and melt/fuse the additional material onto the blank plate segment substrate to produce the feature pattern.

The method can use either a single metallurgy for all added features which may be the same or different from the plate segment substrate, or it can use multiple metallurgies such as on the bottom and top of the features, the middle (e.g., core), and/or outer surfaces of the features, the different surfaces/sides of the features, different parts of the plate segments or different zones in the plate segments, and/or different plate features (e.g., making dams of a different material). The resulting plate segment may be used directly, and/or heat-treated and/or re-ground to a flat, tapered, conical, cylindrical surface.

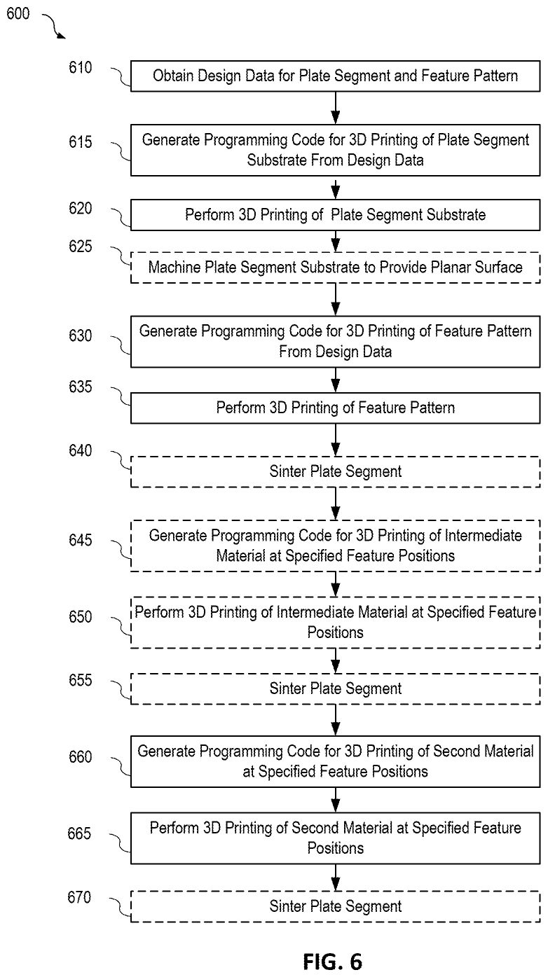

FIG. 6 is a flowchart illustrating an example of a method 600 for additive machining of a plate segment according to some aspects of the present disclosure. Referring to FIG. 6, at block 610, design data for a plate segment may be obtained. The plate segment design data may include design data for the plate segment substrate and the feature pattern for the plate segment. The plate segment may be, for example, but not limited to, a refiner plate, a disperser plate, a flinger plate, etc., and may include an appropriate feature pattern (e.g., bars, grooves, dams, etc.) for the particular application. In some cases, features in the feature pattern may be dimensioned such that the features are wider at a top surface than at a base of the feature.

At block 615, programming code for 3D printing of the plate segment substrate may be generated. The programming code for 3D printing of the plate segment substrate may be generated automatically from the plate segment design data. The plate segment substrate design data may specify the overall dimensions of the plate segment substrate, for example, but not limited to, shape, thickness, mounting hole location, etc. The generated programming code may be code for operating computer numerical controlled (CNC) 3D printing equipment.

At block 620, an operation of 3D printing of the plate segment substrate may be performed. Based on the code generated from the plate segment design data, the plate segment substrate may be 3D printed. The plate segment substrate may be printed from a first material having properties that may provide resistance to breakage.

At block 625, an optional planarization operation may be performed. The plate segment substrate may be machined to obtain a planar surface such that the top surface of the plate segment substrate lies in a same plane. In the case of a curved plate segment, the optional planarization operation may result in the plate segment substrate having a uniform thickness

At block 630, programming code for 3D printing of the feature pattern may be generated. The generated programming code may be code for operating computer numerical controlled (CNC) 3D printing equipment. The programming code for 3D printing of the feature pattern may be generated automatically from the plate segment design data. The plate segment design data may specify the types and dimensions of features for example, but not limited to bars, grooves, dams, etc., and their locations on the plate segment substrate.

At block 635, an operation of 3D printing of the feature pattern may be performed. Based on the programming code generated from the plate segment design data, the feature pattern may be 3D printed on the plate segment substrate. In some cases, for example when the features are printed from a different material than the material from which the plate segment substrate was fabricated, an intermediate material may be applied to the plate segment substrate in a same pattern as the feature pattern to promote secure bonding the plate segment substrate material to the material from which the features of the feature pattern will be fabricated.

At block 640, an optional sintering operation may be performed. The sintering operation may be performed to fuse the material from which the features are fabricated to the material from which the plate segment substrate is fabricated (or the intermediate material when used) thereby increasing the strength and structural integrity of the materials. The sintering may be performed as the material for the feature pattern is printed on the plate segment substrate, for example, using a laser sintering process. Alternatively or additionally, the sintering may be accomplished by heat treating the plate segment (e.g., the plate segment substrate and 3D printed feature pattern).

At block 645, an intermediate material may optionally be applied. In some cases, an intermediate material may be applied to promote a strong bond between the material from which the plate segment is fabricated and a more wear resistant material to be added to features in the feature pattern. When an intermediate material is to be applied, an optional operation of generating programming code for 3D printing of the intermediate material at specified feature positions may be performed. The intermediate material may be applied to effect secure bonding the first material to a second material. The features to which the intermediate material will be applied may be selected by an operator. The generated programming code may be code for operating computer numerical controlled (CNC) 3D printing equipment. The programming code for 3D printing of the intermediate material may be generated automatically from the feature pattern design data.

At block 650, when an intermediate material is to be applied, an optional operation of 3D printing of the intermediate material at the specified feature positions may be performed. Based on the programming code generated from the feature pattern design data and the selected features, the intermediate material may be 3D printed on the features at the identified locations.

At block 655, when an intermediate material is to be applied, an optional sintering operation may be performed. The sintering operation may be performed to fuse the intermediate material to the first material thereby increasing the strength and structural integrity of the materials. The sintering may be performed as the intermediate material is printed on the identified features, for example, using a laser sintering process. Alternatively or additionally, the sintering may be accomplished by heat treating the plate segment.

At block 660, programming code for 3D printing of the second material at specified feature positions may be generated. The second material may be a more wear resistant material to be added to identified features in the feature pattern. The features to which the intermediate material will be applied may be selected by an operator. The generated programming code may be code for operating computer numerical controlled (CNC) 3D printing equipment. The programming code for 3D printing of the second material may be generated automatically from the feature pattern design data and the selected features.

At block 665, an operation of 3D printing of the second material at the specified feature positions may be performed. Based on the programming code generated from the feature pattern design data and the selected features, the second material may be 3D printed on the features at the identified locations. It should be appreciated that the additive machining process may be performed for the addition of more than one second material.

At block 670, an optional sintering operation may be performed. The sintering operation may be performed to fuse the second material to the first material (or the intermediate material when used) thereby increasing the strength and structural integrity of the materials. The sintering may be performed as the second material is printed on the identified features, for example, using a laser sintering process. Alternatively or additionally, the sintering may be accomplished by heat treating the plate segment. In some cases, a planarization operation may be performed on the plate segment.

The specific operations illustrated in FIG. 6 provide a particular method 600 for additive machining of a plate segment according to an embodiment of the present disclosure. Other sequences of operations may also be performed according to alternative embodiments. For example, alternative embodiments of the present disclosure may perform the operations outlined above in a different order. Moreover, the individual operations illustrated in FIG. 6 may include multiple sub-operations that may be performed in various sequences as appropriate to the individual operation. Furthermore, additional operations may be added or removed depending on the particular applications.

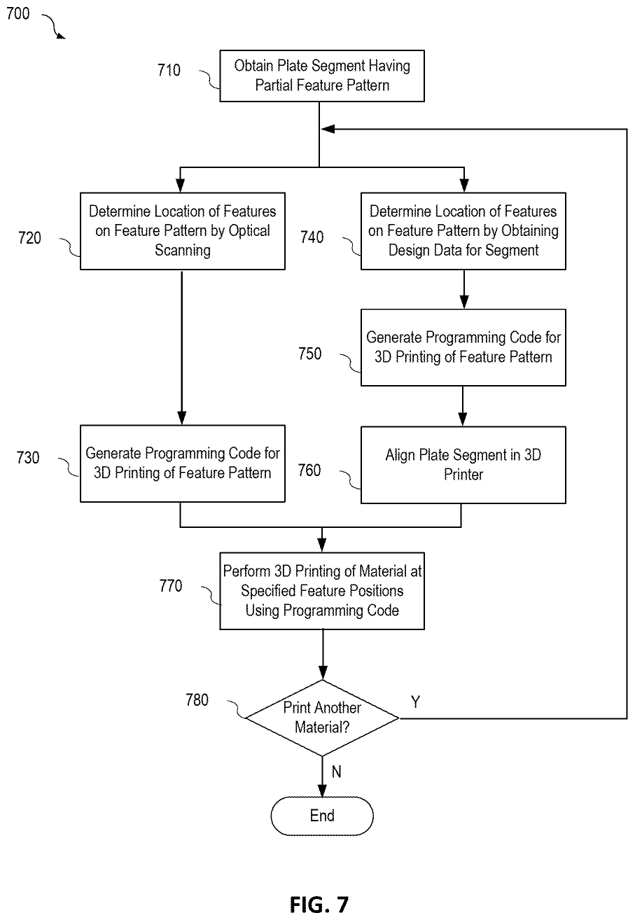

FIG. 7 is a flowchart illustrating an example of a method 700 for additive machining of a plate segment having a partial feature pattern according to various aspects of the present disclosure. Referring to FIG. 7, at block 710, a plate segment with a partial feature pattern may be obtained. The plate segment may be, for example, but not limited to, a refiner plate segment, a disperser plate segment, a flinger plate segment, or other plate segment. The partial feature pattern may include, but not be limited to, bars, grooves, dams, channels, or other features. The plate segment may be fabricated using a casting process or other process. The partial feature pattern may be a feature pattern having features with a height as determined from a plate segment substrate. The height of the partial feature pattern may be less than a designed height for the features. In some cases, features in the feature pattern may be dimensioned such that the features are wider at a top surface than at a base of the feature.

After the plate segment with a partial feature pattern is obtained, the location of the features in the feature pattern may be determined by optical scanning (block 720) or by obtaining the design programming code for the feature pattern for the plate segment (block 740).

At block 720, the location of the features on the feature pattern may be determined by optical scanning. The plate segment may be scanned to determine positions of the features in the feature pattern. The plate segment may be scanned by, for example, but not limited to, 3D laser scanning equipment or other optical scanning equipment, acoustic-based scanning equipment, radar-based scanning equipment, etc. The scanning operation may identify a perimeter of the plate segment and may generate a three-dimensional map that defines the positions and dimensions of the features in the feature pattern with respect to the perimeter of the plate segment. Thus, no specific alignment of the plate segments may be needed.

At block 730, programming code for 3D printing of the feature pattern may be generated. The programming club maybe generated from the optical scanning data of the feature pattern. The generated programming code may be code for operating computer numerical controlled (CNC) 3D printing equipment. The programming code for 3D printing of the intermediate material may be generated automatically from the 3D scanning data of the feature pattern.

Alternatively, at block 740, the location of the features on the feature pattern may be determined by obtaining design programming code for the feature pattern. The plate segment design programming code may include design data for the plate segment substrate and the feature pattern for the plate segment.

At block 750, programming code for 3D printing of the feature pattern may be generated. The programming club maybe generated from the design data of the feature pattern. The generated programming code may be code for operating computer numerical controlled (CNC) 3D printing equipment. The programming code for 3D printing of the intermediate material may be generated automatically from the design data of the feature pattern.

At block 760, the plate segment with the partial feature pattern may be positioned on the 3D printing equipment. Precise positioning of the plate segment may be achieved using locations of selected features of the feature pattern based on the design data of the feature pattern.

At block 770, an operation of 3D printing of the feature pattern on the plate segment having a partial feature pattern may be performed. Based on the programming code generated from the optical scan or plate segment design data, the feature pattern may be 3D printed.

At block 780, it may be determined whether another material will be 3D printed. For example, it may be determined whether a subsequent material having different properties, for example, but not limited to, wear-resistance or other properties, may be 3D printed. In response to determining that a subsequent material will be 3D printed (780—Y), the method may continue to determine the location of features of the feature pattern at block 720 or block 740.

In response to determining that a subsequent material will not be 3D printed (780—N), the method may end.

It should be appreciated that when more than one material is to be 3D printed, the locations to be printed on the feature pattern may be determined by optical scanning or design data or combinations of optical scanning and design data.

The specific operations illustrated in FIG. 6 provide a particular method 600 for additive machining of a plate segment having a partial feature pattern according to an embodiment of the present disclosure. Other sequences of operations may also be performed according to alternative embodiments. For example, alternative embodiments of the present disclosure may perform the operations outlined above in a different order. Moreover, the individual operations illustrated in FIG. 6 may include multiple sub-operations that may be performed in various sequences as appropriate to the individual operation. Furthermore, additional operations may be added or removed depending on the particular applications.

While the above methods are described as being applied to refiner plate segments, the disclosed methods may be applied to other types of plate segments, for example, but not limited to, disperser plate segments, flinger plate segments, etc., as well as complete disc-type refiner plates, disperser plates, flinger plates, etc., without departing from the scope of the present disclosure. Further, the disclosed methods may be applied to flat, conical, and cylindrical plate segments as well as single-piece circular plates without departing from the scope of the present disclosure.

The examples and embodiments described herein are for illustrative purposes only. Various modifications or changes in light thereof will be apparent to persons skilled in the art. These are to be included within the spirit and purview of this application, and the scope of the appended claims, which follow.

What is claimed is:

1. A method for additive machining of a refiner plate segment having a feature pattern, the method comprising:
fabricating the refiner plate segment with a partial feature pattern from a first material;
performing first optical scanning of the refiner plate segment to identify positions of features in the partial feature pattern;
automatically generating first code for performing three-dimensional (3D) printing of a second material at first specified locations in the partial feature pattern from data obtained from the optical scanning; and
performing 3D printing of the second material at the specified locations.

2. The method of claim 1, wherein the second material has a hardness greater than the hardness of the first material.

3. The method of claim 1, sintering the second material by heating the refiner plate segment after the 3D printing of the second material.

4. The method of claim 1, further comprising:
after fabricating the refiner plate segment with the partial feature pattern, performing a planarization operation to obtain a planar surface on top surfaces of the features in the partial feature pattern.

5. The method of claim 1, further comprising:
positioning the refiner plate segment in a predetermined orientation in three-dimensional (3D) printing equipment;
obtaining pre-programmed second code for performing three-dimensional (3D) printing of a third material at second specified locations in the partial feature pattern; and
performing 3D printing of the third material at the specified locations using the pre-programmed second code.

6. The method of claim 1, further comprising:
positioning the refiner plate segment in three-dimensional (3D) printing equipment;
performing second optical scanning of the refiner plate segment to identify the positions of the features in the partial feature pattern;
automatically generating second code for performing three-dimensional (3D) printing of a third material at second specified locations in the partial feature pattern from data obtained from the second optical scanning; and
performing 3D printing of the third material at the specified locations.

7. The method of claim 1, further comprising:
performing 3D printing of two or more additional material at the specified locations based on the first code for performing three-dimensional (3D) printing.

8. The method of claim 1, wherein the refiner plate segment is a planar refiner plate segment, a cylindrical refiner plate segment, a conical refiner plate segment, or a single piece circle.

9. A method for additive machining of a blank refiner plate segment without a feature pattern, the method comprising:
fabricating the blank refiner plate segment without feature pattern from a first material;
generating code for performing three-dimensional (3D) printing of the feature pattern from design data for the feature pattern; and
performing 3D printing of the feature pattern on the blank refiner plate segment with a second material to form a refiner plate segment having the feature pattern.

10. The method of claim 9, wherein the second material has a hardness greater than the hardness of the first material.

11. The method of claim 9, further comprising:
after fabricating the blank plate segment, performing a planarization operation to obtain a planar surface on the blank refiner plate segment.

12. The method of claim 9, further comprising sintering the second material by heating the refiner plate segment after the 3D printing of the second material.

13. The method of claim 9, further comprising performing 3D printing of the feature pattern with two or more different materials.

14. The method of claim 9, wherein the refiner plate segment has a conical or cylindrical surface or is a single piece circle.

15. A method for refurbishing a feature pattern of a refiner plate segment using additive machining, the method comprising:
obtaining a previously used refiner plate segment comprising a first material;
performing a planarization operation to obtain a planar surface on top surfaces of features in a feature pattern;
performing optical scanning of the refiner plate segment to identify positions of the features in the feature pattern;
automatically generating code for performing three-dimensional (3D) printing of a second material at specified locations in the feature pattern from data obtained from the optical scanning; and
performing 3D printing of the second material at the specified locations in the feature pattern.

16. The method of claim 15, wherein the second material is the same as the first material.

17. The method of claim 15, wherein the second material has a hardness greater than the hardness of the first material.

18. The method of claim 15, further comprising sintering the second material by heating the refiner plate segment after the 3D printing of the second material.

19. The method of claim 15, wherein the refiner plate segment is a planar refiner plate segment, a cylindrical refiner plate segment, a conical refiner plate segment, or a single piece circle.

20. A method for additive machining of a refiner plate segment, the method comprising:
obtaining design data for the refiner plate segment;
generating code for three-dimensional (3D) printing of a refiner plate segment substrate;
performing 3D printing of the refiner plate segment substrate with a first material;
generating code for 3D printing of a feature pattern from the design data for the refiner plate segment; and
performing 3D printing of the feature pattern on the refiner plate segment substrate with a second material.

21. The method of claim 20, wherein the second material has a hardness greater than the hardness of the first material.

22. The method of claim 20, wherein the refiner plate segment substrate and a lower portion of the feature pattern are 3D printed with the first material, and an upper portion of the feature pattern is 3D printed with the second material.

23. The method of claim 20, wherein performing 3D printing of the refiner plate segment substrate comprises 3D printing with multiple alloys.

24. The method of claim 20, further comprising performing 3D printing of the feature pattern with two or more different materials.

25. The method of claim 20, further comprising sintering the second material by heating the refiner plate segment after the 3D printing of the second material.

26. The method of claim 20, wherein the refiner plate segment is a planar refiner plate segment, a cylindrical refiner plate segment, a conical refiner plate segment, or a single piece circle.

27. A method for additive machining of a refiner plate segment having a partial feature pattern, the method comprising:
fabricating the refiner plate segment with a partial feature pattern from a first material based on design data for the refiner plate segment;
positioning the refiner plate segment at a known location and orientation in a 3D printing machine;
and
performing 3D printing to complete features on predetermined features in the partial feature pattern, wherein program code for 3D printing is provided from the design data of the refiner plate segment.

28. The method of claim 27, wherein positioning the refiner plate segment at the known location and orientation is accomplished via a fixture.

29. The method of claim 27, wherein the known location and orientation of the plate segment is determined by performing scanning of the refiner plate segment.
